(19) United States
(12) Patent Application Publication
(10) Pub. No.: US 2016/0372917 A1
(43) Pub. Date: Dec. 22, 2016

(54) Active Intrinsically Safe Circuit

(71) Applicants: William Lowers, Columbus, OH (US); Albert Abnett, Nevada, OH (US)

(72) Inventors: William Lowers, Columbus, OH (US); Albert Abnett, Nevada, OH (US)

(21) Appl. No.: 15/186,397

(22) Filed: Jun. 17, 2016

Related U.S. Application Data
(63) Continuation of application No. 62/181,549, filed on Jun. 18, 2015.

(51) Int. Cl. H02H 9/00

(52) U.S. Cl. CPC H02H 9/008

(57) ABSTRACT

An active intrinsically safe circuit for detecting and mitigating non-compliance of current, voltage, power, or heat to at a load which resides in a hazardous area, where non-compliance may cause danger to life or harm to property. The intrinsically safe circuit monitors current, voltage, power, or heat, shuts off or otherwise limits current, voltage, or power. The intrinsically safe circuit then tests for return of compliance, and acts to restore current, voltage, and power to the load upon return of compliance.

### CROSS-REFERENCE TO RELATED APPLICATIONS

The present application for patent claims the benefit of U.S. Provisional Application Ser. No. 62/181,549, entitled, “ACTIVE INTRINSICALLY SAFE CIRCUIT,” filed Jun. 18, 2015, and hereby expressly incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The subject technology is in the technical field of intrinsically safe circuits, as well as systems, methods, and apparatus making use thereof.

### SUMMARY OF THE INVENTION

Care must be taken so that electrical circuits do not create or allow operation above safe limits for voltage, current, power, or heat that would otherwise be sufficient to ignite gasses, other chemicals, or particles in hazardous areas. Prior art in the area of intrinsically safe current limiting circuit often deploys a means to divert current when an over-voltage or over-current fault arises, generally by diverting current into another electrical device. The other electrical device then generates heat while it further consumes energy from the power source and generally causes a fuse to open the circuit. Heat must be dissipated both to protect the device as well as for retaining compliance and safety in the hazardous area, but the heating must also remain below the Auto Ignition Temperature of all gases and particles expected to be in the process area.

In some instances with respect to direct current power sources, a high current transient may be initiated in normal operation by a capacitance on the load side that is charging up too fast, thus drawing excess current, or other normal circuit operations. Also, high direct current drawn by a load may be caused by a capacitor or perhaps a transistor shorting to ground, causing excess current.

A circuit that continues to draw current that is not delivered to the primary load means that the energy is wasted. When the power source is a battery, the battery must be recharged or replaced more often than would otherwise be necessary. Recharging cycles reduce the life of batteries. Furthermore, if the circuit path is not configured properly with a fuse or other means to shut off current flow, catastrophic results may take place with particular battery technologies such as Lithium-Ion.

Still further, maintaining and accessing battery-powered equipment in the field may be impractical for logistical, geographical, or other reasons.

When the power source is a battery, common problems include battery wear and tear due to avoidable recharging events, battery replacement, and battery power being wasted as heat in traditional intrinsically safe circuits.

Such problems are resolved with an active intrinsically safe circuit which detects a fault, shuts off electrical energy to the load, and then seeks to recover while it tests for current and voltage come back into compliance. Electrical energy can be limited with respect to voltage, current, or power. Still further, in some situations the load requires power for various reasons while the intrinsically safe circuit detects a fault. In such situations, the active intrinsically safe circuit may regulate voltage or current to the load at some minimal level, while it then seeks to test and recover if current and voltage come back into compliance. Among the reasons requiring power even while an over-voltage or over-current event takes places include charging ancillary and auxiliary power at the load (such as provided by a large capacitor) while the load enters a safe sleep mode. Another reason is to supply minimal operational power in order to maintain critical functions that must continue or complete.

In many situations, the intrinsically safe circuit could, if required, still deliver proper power to the load during a fault condition. However, if that cannot not be done, then power has to be prevented from passing to the load.

After detecting a fault, in one embodiment the active intrinsically safe circuit may temporarily engage a switch, acting as an electrical crowbar, to divert current from the load, and then immediately opens the current path to prevent overheating and damage to the switch acting as a crowbar. In other embodiments, the crowbar may be replaced by a voltage regulator. In still other embodiments, the switch acting as a crowbar is unnecessary and may be omitted. In all embodiments, the active intrinsically safe circuit then temporarily creates or uses existing alternative circuit paths in order to test voltage or current from the power source, denies all or a portion of power to the load, and attempts to recover when the current or voltage comes back into compliance.

Generally, use of the switch acting as a crowbar is not effective for active current limitation applications, because cutting off or otherwise limiting current is sufficient to resolve the fault. There is no need to shunt the voltage to ground. However, for active voltage limitation, the switch acting as a crowbar or other means to reduce voltage would be required.

After testing continuously, or until a “stop testing” criteria is reached, the active intrinsically safe circuit either restores current to the load if current from the source comes back into compliance or finally cuts off power to the load until other intervention resolves the root cause of the fault.

Control in the active intrinsically safe circuit is provided by active analog devices, discrete digital logic, digital processors, or combinations thereof. To provide additional safety, the active intrinsically safe circuit may be organized in sets of two or more in various topologies and placed in advantageous connection with each other, between the power source and the load.

Other objects and features of the technology presented herein will become apparent from the detailed description considered in conjunction with the accompanying drawings. It is to be understood, however, that the drawings are designed solely for purposes of illustration and not as a definition of the limits of the invention, for which reference should be made to the appended claims. It is further understood that the drawings are intended conceptual illustrations of the structures and procedures described herein.

### BRIEF DESCRIPTION OF THE DRAWINGS

FIG. 1 shows basic topology of the active intrinsically safe circuit, with fault recovery technology.

FIG. 2 shows current limiting and switch acting as a crowbar.

FIG. 3 shows sensing and control for current fault.

FIG. 4 shows sensing and control for voltage fault.

FIG. 5 shows sensing and control for both current and voltage faults.

FIG. 6 shows in isolation, respectively, current limiting and current shut off, with the testing and recovery circuit, with an alternative for voltage only testing.

FIG. 7 is a flow diagram for current fault where the current is to be shut off.

FIG. 8 shows recovery involving current limiting circuit.

FIG. 9 shows recovery involving a voltage limiting circuit.

FIG. 10 shows recovery in combined current and voltage limiting circuit.

FIG. 11 shows an embodiment of the active intrinsically safe circuit for combined current and voltage limiting with separate current sensing and voltage.

FIG. 12 shows three instances of active energy limiter circuits, arranged for redundancy.

FIG. 13 is a block diagram representation of an analog embodiment, for over-current protection.

FIGS. 14A and 14B, respectively, show a block diagram of over-current sensor and fault as anticipated in FIG. 13.

FIG. 15 shows a further embodiment of three instances of active energy limiter circuits, placed in series and served by a single fault recovery circuit.

FIG. 16 shows an embodiment of separation and use of a single fault recovery circuit to serve three active energy limiters.

### DETAILED DESCRIPTION OF THE INVENTION

In these descriptions, we may generally refer to voltage, current, or power generically as electrical energy or energy. However, specific applications of active current, active voltage, or active power limitation are contemplated in the embodiments.

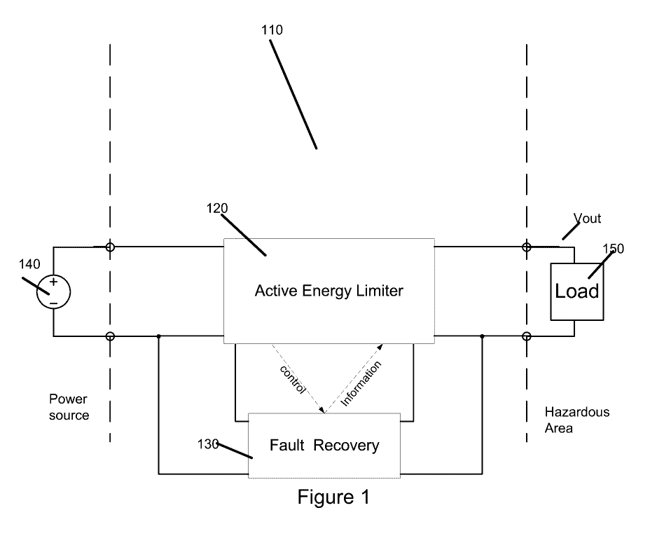

FIG. 1 shows the general concept of an intrinsically safe circuit 110 placed between an electrical energy source and a load 150, where the intrinsically safe circuit 110 is in a hazardous area. An electrical energy source 140 may entail direct or alternating current. A fault recovery circuit 130 is connected generally in parallel so as to be able to monitor and control voltage and current from the source. Together, the active energy limiter 120 the fault recovery circuit 130 comprise the intrinsically safe circuit 110. When a fault arises, such as an over-current or over-voltage condition, the active energy limiter 120 will cut off or otherwise limit voltage or current to the load 150. Thus, the load 150 is protected. After that, the fault recovery circuit 130 engages, upon information from and control from the intrinsically safe circuit 110 indicating that a fault occurred. The fault recovery circuit 130 then tests voltage and/or current for return to compliance. Upon return of voltage and/or current to compliance, the fault recovery circuit 130 provides information and control to the active energy limiter 120 to return full voltage and/or current to the load 150.

The intrinsically safe circuit 110 generally may still deliver proper electrical energy 142 to the load 150 during a fault condition, if so required. In such cases, testing for recovery must be done under an appropriate load 150 in order to verify that voltage, current, or power formerly at fault, but actually being delivered under proper load 150 conditions, has returned to compliance. However, if the fault remains while power is being delivered to the load 150, then power, as electrical energy 142, to the load 150 must be prevented.

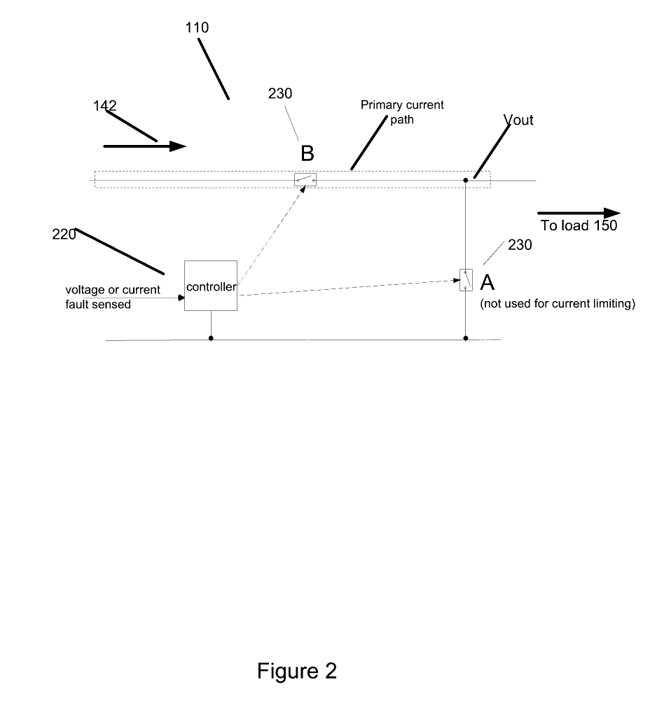

FIG. 2 is an implementation of the intrinsically safe circuit 110 comprising a controller 220, a current pass element 240 (shown generically as a switch 230 “B,” but could be another limiting component), and a shunt 320ing, or switch 230 “A,” shown as crowbar. A primary current path to the load 150 is through switch 230 “B.” In many situations, this may not be needed, but is disclosed here for discussion. The controller 220 may be processor-based, discrete digital logic, analog, or any combination thereof. The controller 220 monitors for an over-voltage or over current condition. Upon detecting such, it first engages the switch 230 “A,” if present, to send voltage (denoted as Vout) to zero and to divert current to ground and away from the load 150. This often creates considerable stress on switch 230 “A” as current flows through it. It also wastes energy from the electrical energy source 140. In order to relieve the stress, the controller 220 then disengages the current pass element 24b “B” so as to deny current flow towards the load 150 and towards the switch 230 “A”.

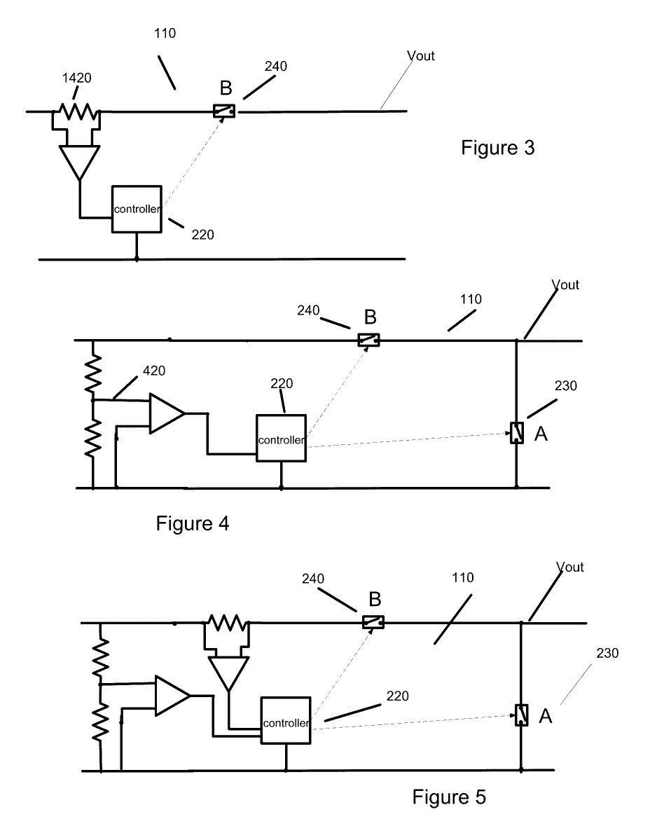

FIG. 3 expands on the implementation to show detection on an over-current condition by use of measuring the voltage drop across a shunt resistor 1420 and from that computing the current through it. With some current compliance reference established in the circuit, if value of current as computed from the voltage drop across the shunt resistor 1420 exceeds the current compliance reference, then the controller 220 disengages the current pass element 240 at “B” as previously described.

FIG. 4 is a variation to detect an over-voltage condition by measuring the voltage between ground and a reference voltage 420. With some voltage compliance reference established in the circuit, if value of voltage at input exceeds compliance with respect to the reference voltage 420, then the controller 220 engages the switch 230 “A” and disengages the current pass element 240 at “B” as previously described.

FIG. 5 is a combined implementation that checks for and reacts to both over-current and over-voltage conditions, either of which directs the controller 220 to engage the switch 230 “A” (for active voltage limitation) and disengage the current pass element 240 at “B” as previously described.

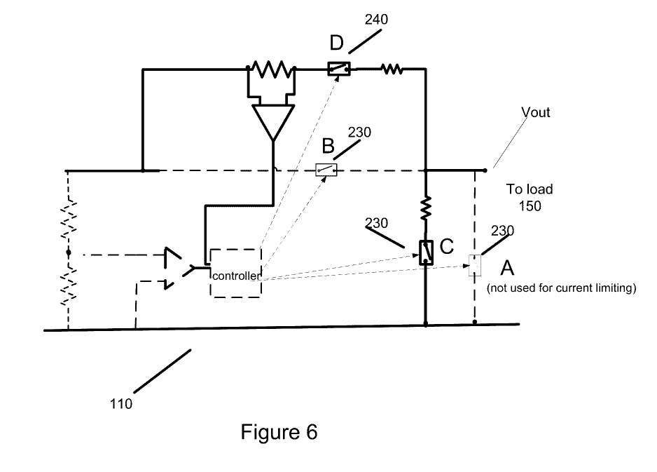

FIG. 6 adds testing and recovery circuitry to the combined implementation of FIG. 4. An additional over-current detection circuit, current pass element 240 “D,” and switch 230 “C” are added as shown. Intrinsically safe components used in previous figures are shown in dashed lines, to indicate relative placement of the testing and recovery circuit. In this implementation both the load 150 side of current pass element 240 “D” and the non-grounded side of switch 230 “C” are connected to Vout. In an alternative implementation, pass element 240 “D” and switch 230 “C” may be in series creating a path for the current from input to ground through pass element “D” and switch 230 “C.” As shown in FIG. 6, however, the controller 220 further engages or disengages pass element 240 “D” and switch 230 “C” to create an alternate path for testing current and/or voltage from the source. The general idea is to test until voltage and/or current returns to compliance, and then to re-engage switch 230 “B” to allow current to flow to the load 150 through the primary path. If the voltage and/or current does not return to compliance but a “stop testing” criteria is reached, switch 230 “B” remains in the open state, power is not reinstated to the load 150, and no further testing takes place.

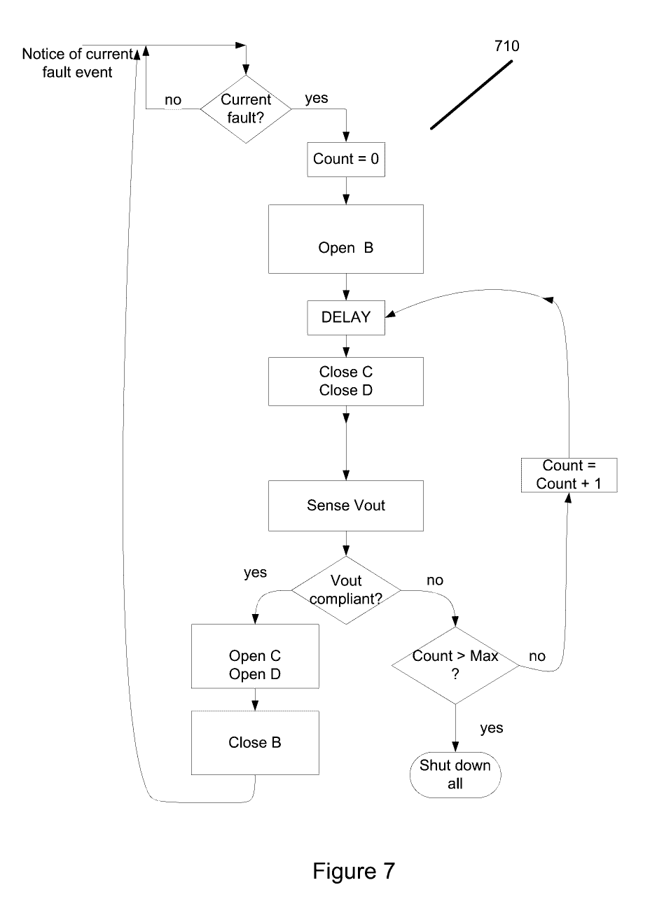

FIG. 7 is a flow chart 710, applied to the configuration of FIG. 6, generally showing the control of switch 230 “B,” switch 230 “C,” and pass element 240 “D” so as first to protect the load 150 from over current, then to test for compliance while the load 150 is protected, and finally return power to the load 150 upon return of compliance. The embodiment contemplated in FIG. 7 pertains to complete shut off of current to the load 150 upon detection of an over-current fault. However, the method can be adapted to allow some current to pass to the load 150 during a fault, to detect over-voltage conditions under load, to operate with or without switch 230 “C,” and with other variations that a particular design may require. Upon detecting a fault, current pass element 240 “B” is disengaged to cut current to the load 150. Then alternate paths are created, by closing pass element 240 “D” and switch 230 “C.” When current, as measured via an additional over-current detection circuit 620, returns to compliance then Vout is also compliant. The method in FIG. 7 tests a certain number of times, but may be revised to test indefinitely or until some other condition arises. When testing indicates that Vout and current have returned to compliance, then power is returned to the load 150: switch 230 “C” and pass element 240 “D” are opened, and then switch 230 “B” is closed. Power to the load is restored, and further fault detection 710 takes place.

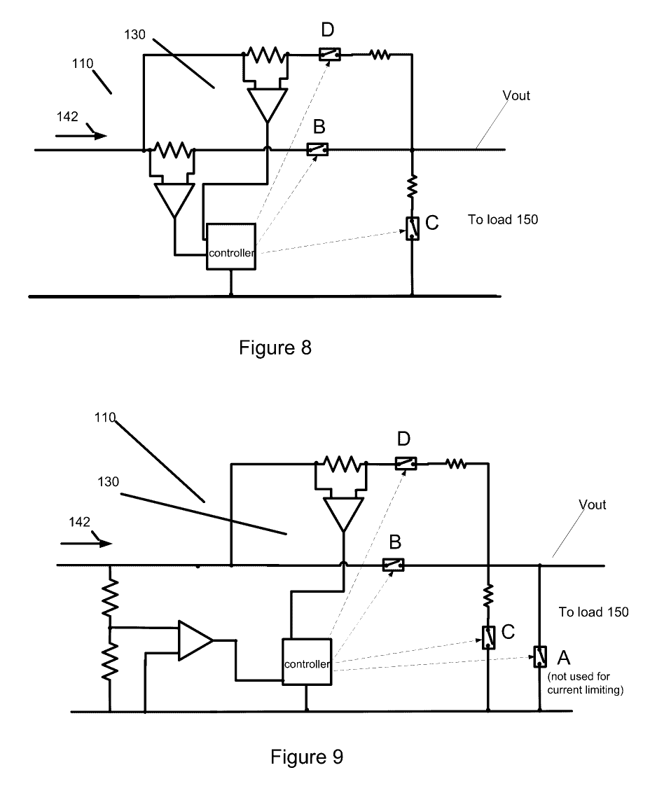

FIGS. 8 and 9 show embodiments of the active intrinsically safe circuit 110 with fault recovery circuit 130, respectively, solely detecting over-current (FIG. 8) and over-voltage (FIG. 9). In both, electrical energy 142 is allowed to flow to the load 150, during recovery testing.

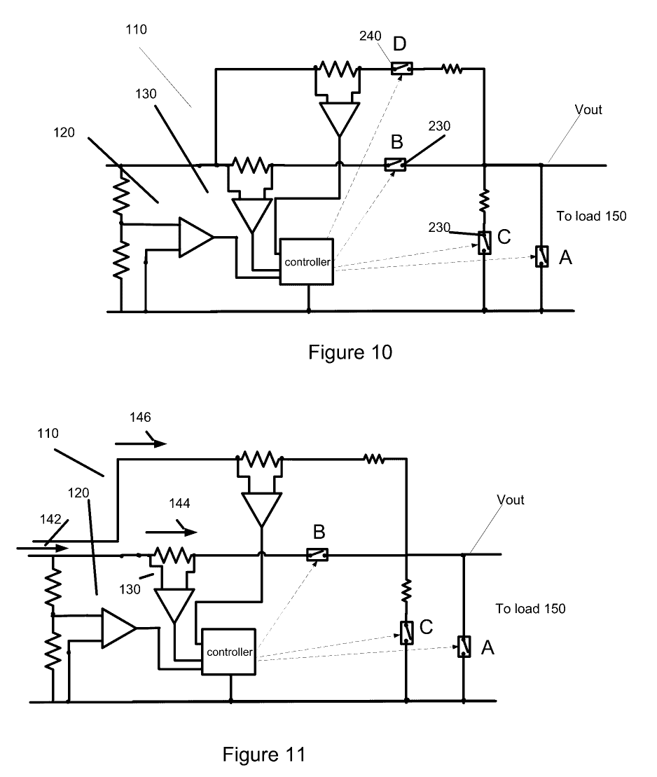

FIG. 10 shows a further embodiment of the fault recovery circuit 130 connected to the active energy limiter 120. In FIG. 10, as discussed above with respect to FIG. 6, some energy is still delivered to the load 150 because of how pass element 240 “D” and switch 230 “C” are connected to the load 150. When switch 230 “B” is disengaged while pass element 240 “D” and switch 230 “C” are engaged, limited electrical energy 142 can still flow to the load 150 through pass element 240 “D.”

In an alternative embodiment, not shown in FIG. 10, pass element 240 “D” and switch 230 “C” are not connected to the primary power path. When switch 230 “B” is disengaged, power is shut off from the load 150. And yet, when pass element 240 “D” and switch 230 “C” are engaged, testing recovery can take place while the load 150 receives no power.

FIG. 11 is yet another embodiment of the intrinsically safe circuit 110, further with separate sensing combined with complete current shut off upon detection of an over-voltage and/or over-current condition. A primary path 144 and a secondary path 146 for electrical energy 142 are provided. Separate sensing of voltage or current along the primary path 144 and the secondary path 146, with respect to active energy limiter 120 and fault recovery 130, may be convenient or required.

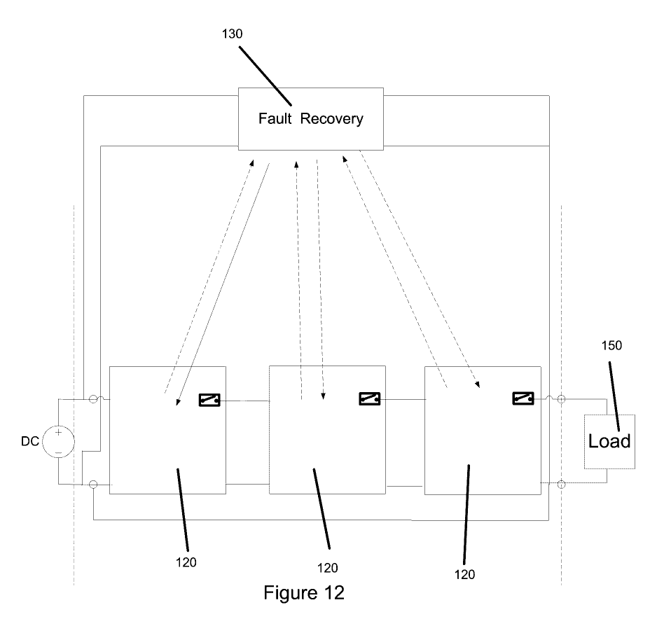

Intrinsic safety standards dictate whether single, double or triple redundancy is required based upon a particular ignition/explosion risk category for which certification is sought. FIG. 12 shows an embodiment and implementation of triple redundancy, where three instances of active energy limiters 120 may operate independently, with each detecting over-current or over-voltage faults and limiting or denying power to the load 150 accordingly. FIG. 12 shows one fault recovery circuit 130 serving all instances. An alternative would have fault recovery circuits 130 deployed in each instance of active energy limiter 120.

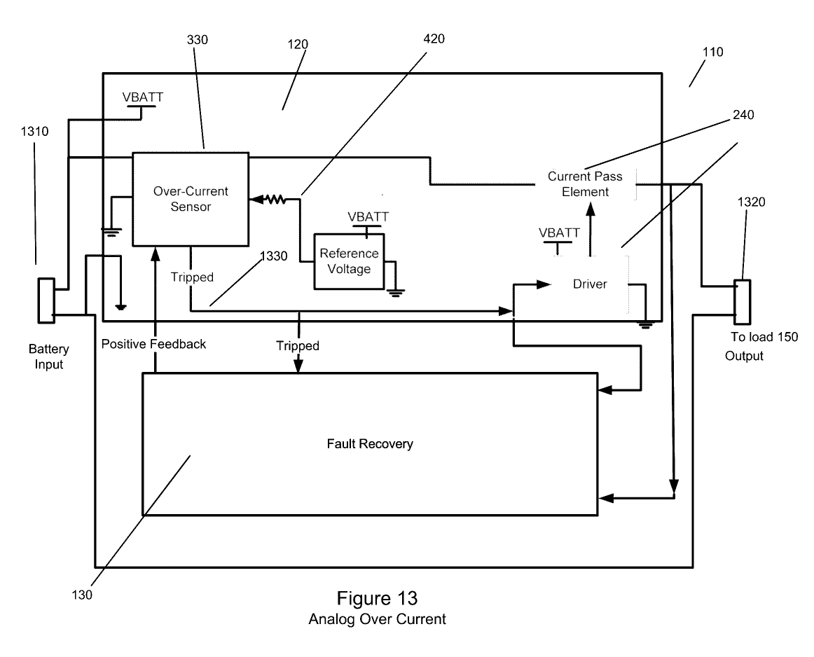

FIG. 13 is a specific embodiment of the intrinsically safe circuit 110 with analog control, allowing minimal power to the load 150 upon detection of an over-current condition, having primary power cut off except for testing purposes. The minimal power could be used, for example, to charge a large capacitor or small battery at or in the load 150, where such an auxiliary storage device would supply minimal power while primary power is cut off. It is contemplated here that the load 150 could sense the loss of primary power and enter a “sleep” mode, which is powered by the auxiliary storage device. Not all configurations of the load 150 have a large capacitor to supply enough current to support a sleep mode. The use of the auxiliary storage device described here is only for an example of a possible configuration.

The active energy limiter 120 of FIG. 13 includes an over-current sensor 330, voltage reference voltage 420, current pass element 240, and driver 1370. Electrical energy 142 enters through an input 1310 connection, through the over-current sensor 330, through the current pass element 240, through an output 1320 connection, and to the load 150. Current from the source also supplies power to the various components. The current pass element 240 is typically a P-channel MOSFET device, but may be any suitable device which is normally conducting and which meets other design requirements. The driver 1370 enables or disables the current pass element 240 in order to allow or to deny, respectively, passage of electrical energy 142 to the load 150. A reference voltage 420 supplied to the over-current sensor 330 establishes the design criteria for detecting an over-current condition.

The driver 1370 plays a particularly important role regarding intrinsic safety. The driver 1370 must react quickly, according to design parameters, to disable the current pass element 240. A time delay beyond certain criteria would endanger life and property to be protected.

When current through the over-current sensor 330 exceeds settable design criteria, thus indicating current is too high for the load 150, the over-current sensor 330 will trip high, as indicated by the tripped 1330 signal sent to the driver 1370 and to a fault recovery circuit 130. This in turn causes two events. A first event is that the tripped 1330 signal is conveyed to the driver 1370, which is fast switching according to design parameters, which in turn disables the current pass element 240. Thus, current to the load 150 is shut off. A second event is that the tripped 1330 signal initiates a reset/retry sequence in a fault recovery circuit 130.

The fault recovery circuit 130 monitors output of the current pass element 240, and compares it with settable design criteria established within the fault recovery circuit 130. The fault recovery circuit 130 also monitors the tripped 1330 signal in two places. This is, in effect, creates positive feedback 1340 needed to introduce hysteresis, which is needed to prevent unwanted on/off switching of the over-current sensor 330 and at the current pass element 240. The duration and period of the resetting of the over-current sensor 330 are settable by design. With current momentarily flowing to the load 150, current can again be tested for compliance. If current still exceeds settable design criteria, then over-current sensor 330 will trip high again, and again causing the driver 1370 to disable the current pass element 240.

If the newly restored current still exceeds the design limits, then the over-current sensor 330 will again trip, the driver 1370 will again disable the current pass element 240, and current to the load 150 will again be shut off. The reset/retry sequence will begin again.

The over-current sensor 330 and fault recovery circuit 130 are further explained below.

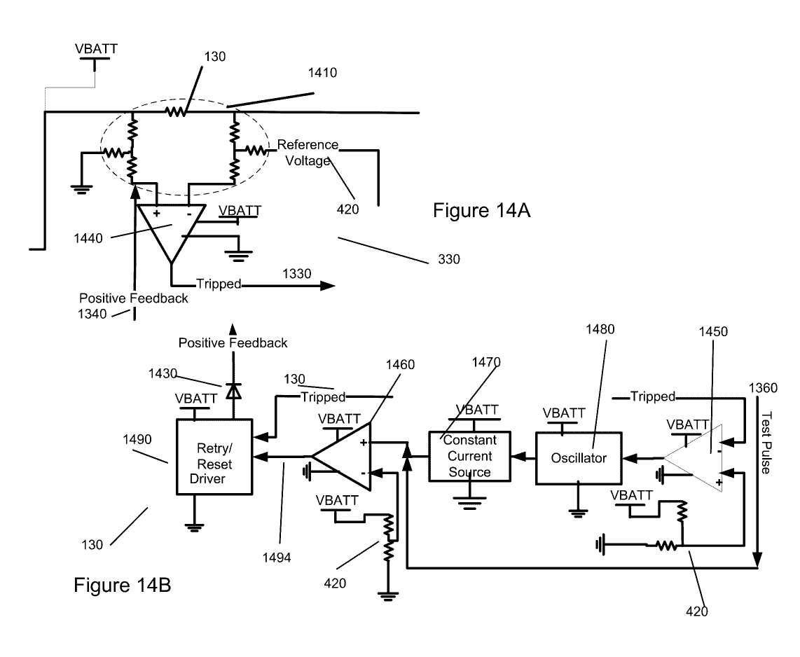

FIG. 14A shows the over-current sensor 330 in greater detail, comprising a first comparator 1440, a resistor network 1410, and a reference voltage 420. The resistor network 1410 further comprises a shunt resistor 1420 through which primary current passes, and other resistors in a bridge configuration. The resistor network 1410 in combination with a reference voltage 420 establish a set point at which when current through the shunt resistor 1420 exceeds the set point, the first comparator 1440 comparator will trip, causing its output tripped 1330 to go high. This is the first event, as described above. The tripped 1330 output will remain high until appropriately designed positive feedback 1340, from the fault recovery circuit 130, is applied to the first comparator 1440 at a positive input. Thus, the first comparator 1440 resets and causes the tripped 1330 output to go low.

FIG. 14B shows the fault recovery circuit 130. The fault recovery circuit 130 comprises a second comparator 1450, an oscillator 1480, a constant current source 1470, a third comparator 1460, a retry/reset driver 1490, and a diode 1430.

Upon initiation of the second event, the tripped 1330 output from the over-current sensor 330 initiates the reset/retry sequence. The tripped 1330 output is compared at the second comparator 1450 with a second reference voltage 420, so that the output of the second comparator 1450 enables the oscillator 1480. The oscillator 1480 defines retest/retry timing. Oscillator 1480 output is applied to the constant current source 1470 that, along with the test pulse 1360 (which is a sensing of the voltage at the load 150), is applied to positive input of a third comparator 1460. A third reference voltage 420, set according to design parameters, is applied to negative input of the third comparator 1460. Output of the third comparator 1460 comprises reset signals 1494 following the timing of the oscillator 1480, passed on to the reset/retry driver 1490.

The reset/retry driver 1490 manages feedback from the tripped 1330 output of the first comparator 1440 to be applied, after conditioning, to the positive input of the first comparator 1440, resulting in conditioned feedback. Conditioned feedback is a result of applying timing of the reset signals to the tripped 1330 output. The conditioned feedback is modulated by the timing of the reset signal 1494. Positive feedback 1340 comprises the passing of the conditioned feedback through a diode 1430 of sufficient low leakage current to prevent current flow that would otherwise inhibit over-current detection according to design parameters.

Positive feedback 1340 is applied to the first comparator 1440 positive input thereby introducing hysteresis that prevents unwanted switching and/or oscillation of the first comparator 1440 and the tripped 1330 output.

Thus, the tripped 1330 output, after being set high because of detection an over-current condition, is momentarily reset to the non-tripped state according to the timing of the reset pulses.

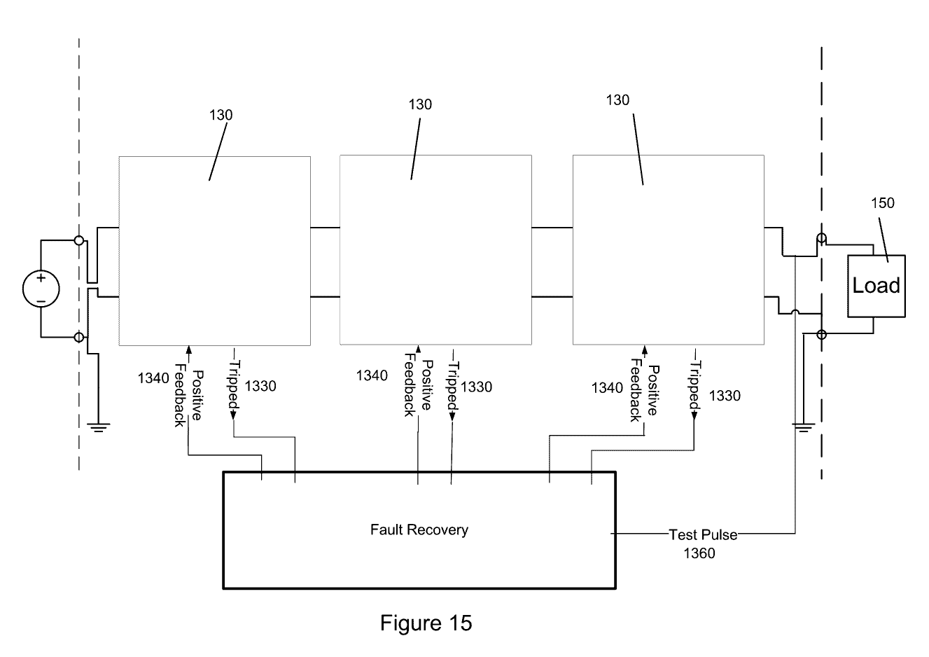

FIG. 15 shows a three-channel embodiment of the intrinsically safe circuit 110. The three-channel embodiment comprises three substantially identical analog intrinsically safe current limiter modules in series with respect to current passed to the load 150. Each may detect an over-current condition from current passed through each. Each may cause tripped 1330 output, which in turn disables the respective current pass element 240 and initiates reset/retry operations. A single fault recovery circuit 130 receives tripped 1330 from each, and supplies positive feedback 1340 to each. Thus, reset/retry operations proceed. When current is restored to compliance, the particular active current limiter 120 that tripped 1330 will enable the respective current pass element 240.

Primary purposes of intrinsically safe circuits 110 include disabling power, current, or voltage when certain parameters are exceeded. Of course, complete embodiments of the intrinsically safe circuit 110 with analog control, including both analog intrinsically safe current limiter and fault recovery circuits 130, may be connected in series. That is to say, they may be connected without separation and use of single fault recovery circuits 130 to serve each active energy limiter 120. However, the use of one single fault recovery circuit 130 serving more than one active energy limiter accomplishes that primary purpose. Failure of any single fault recovery circuit 130 only means that energy may not be restored without other intervention.

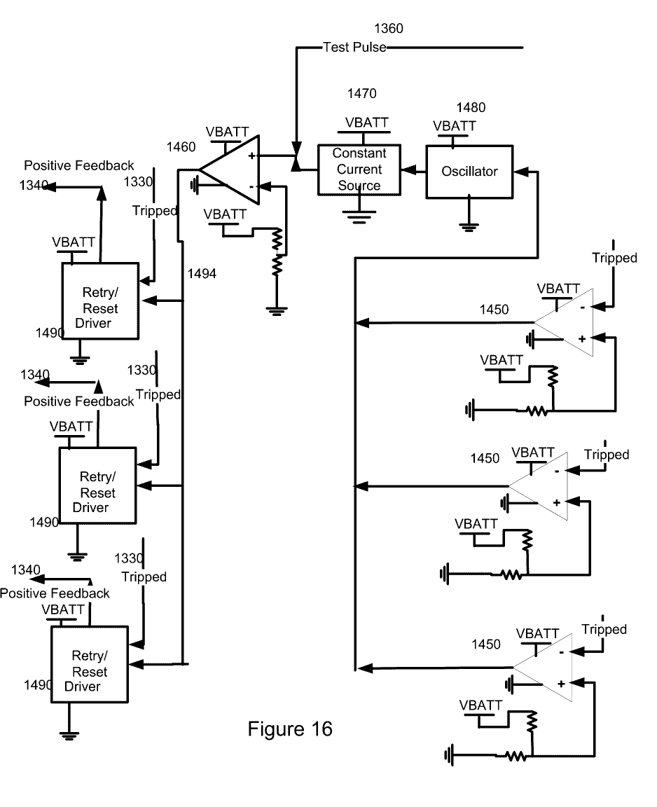

FIG. 16 shows an embodiment of separation and use of a single fault recovery circuit 130 to serve three active energy limiters 120. Tripped 1330 output is received from each active energy limiter, to enable operation of the single oscillator 1480, and further to engage the single third comparator 1460. Output of the single third comparator 1460, along with individual tripped 1330 output, results in positive feedback 1340 for each particular active energy limiter 120.

We anticipate that the system will include other features, including:
Use where the power source is alternating current.
Use of voltage regulator in place of switch acting as a.
Minimal current is supplied to charge a capacitor or other auxiliary short term power at the load while waiting for voltage and/or current compliance.
Minimal current is supplied to keep critical functions alive while waiting for voltage and/or current compliance.
Reacting to limit voltage, current, or power when excess heat is detected, regardless of cause. However a reasonable inference could be that excess heat is caused by voltage, current, or power that exceeds design limits.
Extending the embodiments to include intrinsically safe active power limitation, with various means for computing, measuring power, limiting, or regulating power delivered to the load (constant power source)

While the foregoing written description of the fluid transport technology enables one of ordinary skill to make and use what is considered presently to be the best mode thereof, those of ordinary skill will understand and appreciate the existence of variations, combinations, and equivalents of the specific embodiment, method, and examples herein. The intrinsically safe circuit 110 technology presented here should therefore not be limited by the above described embodiments, methods, or examples, but by all embodiments and methods within the scope and spirit of the subject technology.

Fundamental novel features of the technology disclosed herein as applied to preferred embodiments, have thus been presented. Various omissions, substitutions, changes in the form, and changes in detail of the methods described and the devices illustrated, and in their operation, may be made by those of ordinary skill in the art without departing from the spirit of the technology presented. For example, it is expressly intended that all combinations of those elements and/or method steps which perform substantially the same function in substantially the same way to achieve the same results are within the scope of the technology presented. Moreover, it should be recognized that structures and/or elements and/or method steps shown and/or described in connection with any disclosed form or embodiment of the technology may be incorporated in any other disclosed or described or suggested form or embodiment as a general matter of design choice. It is the intention, therefore, to be limited only as indicated by the scope of the claims.

We claim:

1. An intrinsically safe apparatus for connection between a source of electrical energy and a load that receives the electrical energy, comprising
an active energy limiter allowing passage of the electrical energy to the load, wherein said electrical energy meets compliance criteria and establishing a compliant mode, and further maintaining said compliant mode while said compliance criteria is met,
said active energy limiter operating to limit passage of the electrical energy to the load, wherein the electrical energy is noncompliant with said compliance criteria, and further establishing a noncompliant mode,
a fault recovery circuit for intermittent restoration of passage of the electrical energy to the load, said fault recovery circuit being engaged upon establishment of said noncompliant mode,
said fault recovery circuit further establishing a retest/recovery mode wherein said fault recovery circuit intermittently re-engages said active energy limiter and provisionally allowing passage of the electrical energy to the load for further testing according to said compliance criteria, thereby establishing a provisionally compliant mode,
said active energy limiter operating during said provisionally compliant mode such that the electrical energy is again limited if the electrical energy is noncompliant with said compliance criteria, thereby by re-establishing said noncompliant mode,
said active energy limiter operating during said provisionally compliant mode such that the electrical energy is fully restored when the electrical energy meets settable criteria, thereby re-establishing said compliant mode,
and, said active energy limiter and said fault recovery circuit operating indefinitely.

2. The apparatus of claim 1 wherein compliance with intrinsic safety requirements are preserved.

3. The apparatus of claim 1 further comprising one or more channels of said apparatus for the passage of the electrical energy to the load.

4. The apparatus of claim 2 wherein compliance with intrinsic safety requirements is preserved.

5. An intrinsically safe apparatus for connection between a source of electrical energy and a primary load that receives the electrical energy, comprising
an alternative load,
an active energy limiter allowing passage of the electrical energy to the primary load, wherein said electrical energy meets compliance criteria and establishing a compliant mode, and further maintaining said compliant mode while said compliance criteria is met,
said active energy limiter operating to limit passage of the electrical energy to the primary load, wherein the electrical energy is noncompliant with said compliance criteria, and further establishing a noncompliant mode,
a fault recovery circuit for intermittent restoration of passage of the electrical energy to the alternative load, said fault recovery circuit being engaged upon establishment of said noncompliant mode,
said fault recovery circuit further establishing a retest/recovery mode wherein said fault recovery circuit intermittently re-engages said active energy limiter and provisionally allowing passage of the electrical energy to the alternative load for further testing according to said compliance criteria, thereby establishing a provisionally compliant mode,
said active energy limiter operating during said provisionally compliant mode such that the electrical energy to the primary load remains limited if the electrical energy is noncompliant with said compliance criteria, thereby by re-establishing said noncompliant mode,
said active energy limiter operating during said provisionally compliant mode such that the electrical energy is fully restored to the primary load when the electrical energy meets settable criteria, thereby re-establishing said compliant mode,
and, said active energy limiter and said fault recovery circuit operating indefinitely.

6. The apparatus of claim 5 wherein compliance with intrinsic safety requirements are preserved.

7. The apparatus of claim 5 further comprising one or more channels of said apparatus for the passage of the electrical energy to the load.

8. The apparatus of claim 7 wherein compliance with intrinsic safety requirements is preserved.

9. A method for providing intrinsically safe electrical energy between a source of the electrical energy and a load that receives the electrical energy, comprising
allowing passage of the electrical energy to the load, wherein said electrical energy meets compliance criteria and establishing a compliant mode, and further maintaining said compliant mode while said compliance criteria is met,
limiting passage of the electrical energy to the load, wherein the electrical energy is noncompliant with said compliance criteria, and further establishing a noncompliant mode,
intermittent restoration of passage of the electrical energy to the load, said intermittent restoration fault being engaged upon establishment of said noncompliant mode,
said intermittent restoration further establishing a retest/recovery mode wherein and further provisionally allowing passage of the electrical energy to the load for further testing according to said compliance criteria, thereby establishing a provisionally compliant mode,
the electrical energy during said provisionally compliant mode again being limited if the electrical energy is noncompliant with said compliance criteria, thereby by re-establishing said noncompliant mode,
the electrical energy during said provisionally compliant mode being fully restored when the electrical energy meets settable criteria, thereby re-establishing said compliant mode,
and, said whereby the method operates indefinitely.

10. The method of claim 9 wherein compliance with intrinsic safety requirements are preserved.

11. The method of claim 9 further comprising one or more channels for the passage of the electrical energy to the load.

12. The method of claim 11 wherein compliance with intrinsic safety requirements is preserved.
